(19) United States
(12) Patent Application Publication
(10) Pub. No.: US 2009/0051737 A1
(43) Pub. Date: Feb. 26, 2009

(54) LIQUID EJECTING HEAD AND LIQUID EJECTING APPARATUS

(75) Inventor: Nao TAKEUCHI, Matsumoto-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/196,121

(22) Filed: Aug. 21, 2008

(30) Foreign Application Priority Data
Aug. 22, 2007 (JP) 2007-216465

(51) Int. Cl. B41J 2/045

(52) U.S. Cl. 347/68

(57) ABSTRACT

There is provided a liquid ejecting head including an piezoelectric element unit equipped with internal electrodes respectively constituting two poles are alternatively laminated to sandwich a piezoelectric material layer, the piezoelectric element unit having an external connecting portion connected to each of the internal electrodes of each pole on an outer surface of the piezoelectric element unit, and an external circuit board on which a driving IC for driving the piezoelectric element unit is provided and in which a connection wiring which is electrically connected to the piezoelectric element unit is provided. The external connecting portion of the piezoelectric element unit and the connection wiring of the wiring substrate are electrically connected via a connection layer made of an anisotropic conductive material.

### CROSS REFERENCES TO RELATED APPLICATIONS

The present invention contains subject matter related to Japanese Patent Application No. 2007-216465 filed in the Japanese Patent Office on Aug. 22, 2007, the entire contents of which are incorporated herein by reference.

### BACKGROUND

1. Technical Field

The present invention relates to a liquid ejecting head and a liquid ejecting apparatus.

2. Related Art

As an example of an ink jet type recording head in which a part of a pressure generating chamber communicated with a nozzle opening for ejecting an ink drop is constituted by a vibration plate, the ink jet type recording head ejecting an ink drop from the nozzle opening by deforming the vibration plate by a piezoelectric element to apply a pressure to ink in the pressure generating chamber, one that uses a piezoelectric actuator of a vertical vibration mode that is elongated and contracted in an axis direction of the piezoelectric element has been known.

An example of such an ink jet type recording head using a piezoelectric actuator of a vertical vibration mode is disclosed in, for example, JP-A-2004-74740. The ink jet type recording head is equipped with a piezoelectric element forming member formed by a piezoelectric element in which inner electrodes respectively constituting two poles are alternatively laminated to sandwich a piezoelectric material layer, a piezoelectric element unit united to one end side of the piezoelectric element, a head case in which the piezoelectric element unit is accommodated, a film-like wiring substrate in which a driving IC and a connection wiring connected to a plurality of piezoelectric elements are provided, and one end side of the connection wiring of the wiring substrate is connected to an individual electrode and a common electrode of the piezoelectric element.

However, the piezoelectric element and the connection wiring of the wiring substrate are generally electrically connected by a solder, and are mechanically connected by a solder mask, so that a bonding area becomes narrow and bonding strength becomes week. Accordingly, there is a problem in that the connection wiring is peeled off from the piezoelectric element when treating or the like.

Further, there is a problem that it is necessary to plate the piezoelectric element and the wiring substrate with gold or the like in order to connect the piezoelectric element and the wiring substrate with a solder to increase the cost.

Further, when the piezoelectric element and the wire substrate are connected by a solder, there is a problem in that current leakage caused by insulation failure between terminals of the piezoelectric elements that are actually connected, so called migration occurs.

It should be noted here that such a problem exists not only in the ink jet type recording head for ejecting ink, but also similarly in a liquid ejecting head for ejecting liquid except ink.

### SUMMARY

An advantage of some aspects of the invention is to provide a liquid ejecting head and a liquid ejecting apparatus in which reliability is improved by increasing bonding strength between a piezoelectric element unit and a wiring substrate while reducing cost.

According to a first aspect of the invention, there is provided a liquid ejecting head including an piezoelectric element unit equipped with internal electrodes respectively constituting two poles are alternatively laminated to sandwich a piezoelectric material layer, the piezoelectric element unit having an external connecting portion connected to each of the internal electrodes of each pole on an outer surface of the piezoelectric element unit, and an external circuit board on which a driving IC for driving the piezoelectric element unit is provided and in which a connection wiring which is electrically connected to the piezoelectric element unit is provided. The external connecting portion of the piezoelectric element unit and the connection wiring of the wiring substrate are electrically connected via a connection layer made of an anisotropic conductive material.

According to the first aspect of the invention, by uniting the piezoelectric element unit and the wiring substrate with the connection layer, a bonding area can be increased to increase bonding strength. Further, it becomes unnecessary to plate the external connecting portion and the connection wiring with gold or the like when connecting with a solder. Accordingly, cost can be reduced. Further, it can be surely prevented that leakage of current between the external connecting portions and between the connection wirings occurs to improve reliability.

It is preferable that the piezoelectric element unit having piezoelectric elements the piezoelectric elements and the external connecting portions are separated by slits and an electrode non-formed portion in which the external connecting portion is not formed, and the connection layer is provided from an end of the connection wiring to the electrode non-formed portion in the liquid ejecting head according to the first aspect of the invention.

Herewith, short circuit between the external electrodes can be prevented, and a bonding area of the connection wiring can be increased.

It is preferable that the connection layer is provided between the adjacent external connecting portions in the liquid ejecting head according to the first aspect of the invention.

Herewith, insulation property between the adjacent external electrodes can be improved. Accordingly, current leakage caused by insulation failure between the external connecting portions and between the connection wirings, so called migration can be surely prevented.

It is preferable that the liquid ejecting head according to the first aspect of the invention further including a fixing substrate connected to the piezoelectric element unit at a side opposite to a pressure generating chamber, and a head case having an accommodation unit in which the piezoelectric element unit is accommodated and a terminal unit to which an end of the wiring substrate is electrically connected. The wiring substrate is provided to extend from inside the accommodation unit to outside and is electrically connected to the terminal unit via a folded area, and the driving IC is provided in an area opposing the fixing substrate, and the wiring substrate and the fixing substrate are bonded via a first ultraviolet cure adhesive for bonding the driving IC and the fixing substrate, the first ultraviolet cure adhesive being provided in an area opposing the driving IC, and the second ultraviolet cure adhesive provided at both sides of the area to which the first ultraviolet cure adhesive is applied of the driving IC in a direction in which the piezoelectric element unit is disposed in parallel and provided so as to be located closer to the terminal unit than the first ultraviolet cure adhesive.

Herewith, by providing the first ultraviolet cure adhesive and the second ultraviolet cure adhesive, even when the connection wiring of the wiring substrate is bent in order to connect to the terminal unit provided on the head case, it can be prevented that a stress is applied to the connecting portion between the connection wiring of the wiring substrate and the piezoelectric element unit. Accordingly, occurrence of disadvantages that the strength of the connecting portion is weakened and the connecting portion is peeled off. Further, by providing the first ultraviolet cure adhesive and the second ultraviolet cure adhesive, folding property when folding the wiring substrate can be improved to prevent deformation of the wiring substrate. Further, by bonding the driving IC of the wiring substrate and the fixing substrate with the first ultraviolet cure adhesive, heat generated in the driving IC is defused into the fixing substrate via the first ultraviolet cure adhesive. Accordingly, destruction or the like of the driving IC 31 caused by the heat can be prevented. Further, by providing the first ultraviolet cure adhesive and the second ultraviolet cure adhesive, even when the wiring substrate is touched when handling the ink jet type recording head, it can be prevented that a stress is applied to the connecting portion between the connection wiring of the wiring substrate and the piezoelectric element unit and the connecting portion between the connection wiring and the terminal unit of the had case. Herewith, occurrence of disadvantages that the strength of the connecting portions is weakened and the connecting portions are peeled off can be prevented.

According to a second aspect of the invention, there is provided a liquid ejecting apparatus including the liquid ejecting head according to the first aspect of the invention.

According to the second aspect of the invention, a liquid ejecting apparatus whose reliability is improved can be provided.

Other features and advantages of the invention will be apparent from the following description, taken in conjunction with the accompanying drawings.

### BRIEF DESCRIPTION OF THE DRAWINGS

The invention will be described with reference to the accompanying drawings, wherein like numbers reference like elements.

FIGS. 1A and 1B are each a cross sectional view showing a recording head according to a first embodiment.

FIG. 2 is a perspective view showing a piezoelectric element unit according to the first embodiment.

FIGS. 3A and 3B are a plan view and a cross sectional view showing the piezoelectric element unit according to the first embodiment.

FIGS. 4A and 4B are each a cross sectional view showing a manufacturing method of the recording head according to the first embodiment.

FIG. 5 is a diagram schematically showing an example of an ink jet type recording apparatus according to an embodiment.

### DESCRIPTION OF EXEMPLARY EMBODIMENTS

Hereinafter, preferred embodiments of the invention will be described with reference to the accompanying drawings. Not that embodiments described below are described as examples of the invention. Accordingly, all of the structures to be described are not necessarily indispensable components of the present invention.

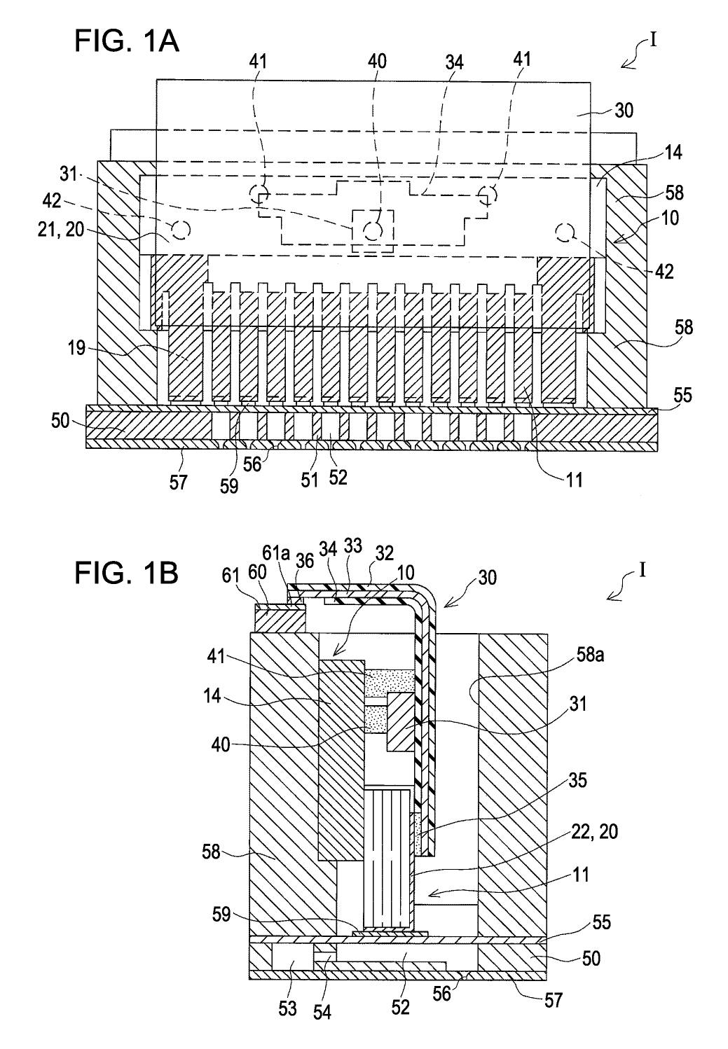

FIG. 1A is a cross sectional view showing a pressure generating chamber of an ink jet type recording head which is an example of a liquid ejecting head according to a first embodiment of the invention in a lateral direction, and FIG. 1B is a cross sectional view showing the pressure generating chamber of the ink jet type recording head in a longitudinal direction. As shown in FIGS. 1A and 1B, a flow path forming substrate 50 is formed by a silicon monocrystalline substrate, and pressure generating chambers 52 which are separated by a plurality of partitions 51 are arranged in the width direction (lateral direction) at a surface layer portion of one surface side thereof. Further, a reservoir 53 for supplying ink which is an example of liquid to each pressure generating chamber 52 is communicated with an end side of each pressure generating chamber 52 in the longitudinal direction via an ink supply opening 54 which is an example of a liquid supply opening. Further, an opening surface side of the pressure generating chamber 52 of the flow path forming substrate 50 is enclosed by a vibration plate 55, and the other surface side of the pressure generating chamber 52 of the flow path forming substrate 50 is bonded to a nozzle plate 57 in which a nozzle opening 56 is opened which is an example of a nozzle forming member via an adhesiveness or a heat adhesive film.

A head case 58 having an ink supply route which is an example of a liquid supply rote connected to an ink cartridge which is an example of plurality of liquid storage body not shown is fixed on the vibration plate 55. Further, a piezoelectric element unit 10 is positioned with a high accuracy and fixed to the head case 58. That is, a penetrated accommodation unit 58a is provided in the head case 58, and the piezoelectric element unit 10 is fixed to an inner surface of the accommodation unit 58a so that a distal end of each piezoelectric element 11 is made contact with each island portion 59 provided in an area corresponding to each pressure generating chamber 52 on the vibration plate 55.

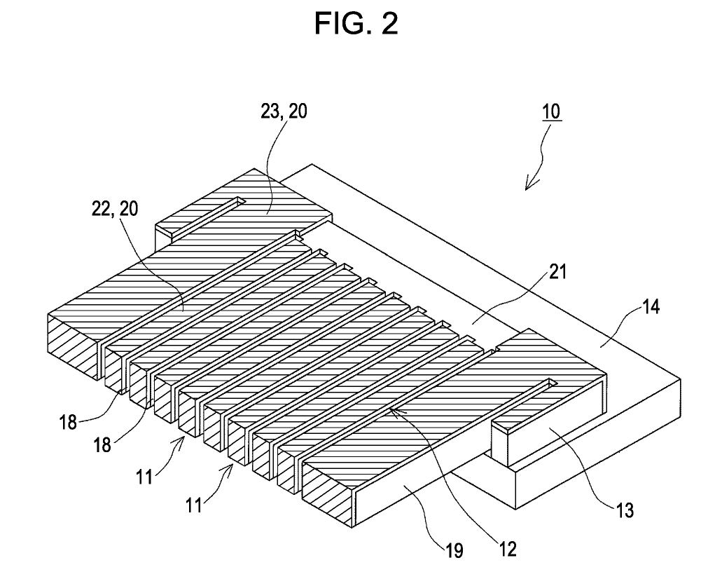

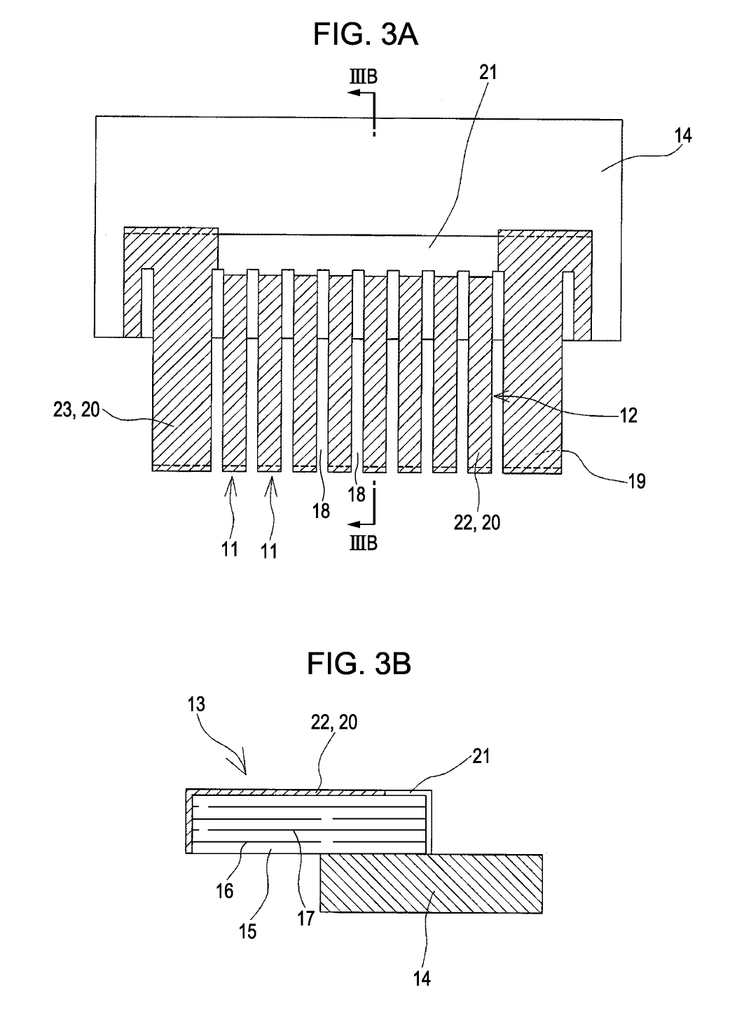

Herein, the piezoelectric element unit 10 will be described in detail. FIG. 2 is a perspective view showing the piezoelectric element unit 10 according to the first embodiment of the invention, FIG. 3A is a plan view of FIG. 2, and FIG. 3B is a cross sectional view taken along the line IIIB-IIIB of FIG. 3A. As shown in FIGS. 2, 3A, and 3B, the piezoelectric element unit 10 according to the invention includes a piezoelectric element forming member 13 having a line 12 in which a plurality of piezoelectric elements 11 are provided in parallel in the width direction and a fixing substrate 14 united to the piezoelectric element forming member 13. An end of each of the piezoelectric elements 11 is united to a side of the pressure generating chamber 52, and the side of each of the piezoelectric elements 11 opposite to the end is united to the fixing substrate 14. The piezoelectric element forming member 13 is formed by alternatively laminating a piezoelectric material layer 15, an internal electrode constituting two poles of the piezoelectric element 11, that is, an individual internal electrode 16 that constitutes an individual electrode which is electrically isolated from the adjacent piezoelectric element 11, and a common internal electrode 17 constituting a common electrode that is electrically common with that of the adjacent piezoelectric element 11 so that each of the individual internal electrode 16 and the common internal electrode 17 is sandwiched by the piezoelectric material layers 15.

A plurality of slits 18 are formed in the piezoelectric element forming member 13 by, for example, a wire-saw or the like. That is, a distal end side of the piezoelectric element forming member 13 is cut to have a comb teeth shape to form the line 12 of the piezoelectric elements 11. However, it is not necessary to form the slits 18. Note that positioning units 19 each having a width larger than that of each piezoelectric element 11 are provided at both outer sides of the line 12 of the piezoelectric elements 11. The positioning units 19 are provided for positioning the piezoelectric element unit 10 with a high accuracy when the piezoelectric element unit 10 is incorporated in an ink jet type recording head I.

Herein, the individual internal electrode 16 which becomes an individual electrode of each piezoelectric element 11 is basically provided over approximately the entire surface of the piezoelectric element forming member 13. However, the individual internal electrode 16 is provided so as to be separated into a distal end side and a proximal end side at an area opposing a vicinity of an end surface of the fixing substrate 14. On the other hand, the common internal electrode 17 which becomes a common electrode is also basically provided over approximately the entire surface of the piezoelectric element forming material 13. However, the common internal electrode 17 is also separated at a vicinity of a distal end of the piezoelectric element 11 similarly to the individual internal electrode 16. That is, an area in which the piezoelectric element 11 and the fixing substrate 14 are united is an inactive region which does not contribute for vibration. When a voltage is applied between the individual internal electrode 16 and the common internal electrode 17 constituting the piezoelectric element 11, only an area of a distal end side of the piezoelectric element 11 which is not united to the fixing substrate 14 vibrates.

Further, an external electrode 20 which is connected to the individual internal electrode 16 and the common internal electrode 17 is formed on an outer surface of the piezoelectric element forming member 13. Further, an electrode non-formed portion 21 in which no external electrode 20 exists exsists at at least a proximal end side of the area opposing the line 12 of the piezoelectric elements 11 of the piezoelectric element forming member 13. A portion of the external electrode 20 which becomes an external connecting portion connected to the individual internal electrode 16 receives a driving signal from outside. Further, a portion of the external electrode 20 connected to the common internal electrode 17 is the one for applying a voltage from outside.

Then, the plurality of slits 18 are formed so as to reach the area opposing the electrode non-formed portion 21. The external electrode 20 is separated by the slits 18 and the electrode non-formed portion 21 to constitute individual external electrodes 22 which are electrically isolated from the adjacent piezoelectric element 11 and the common external electrode 23 which is electrically common with the adjacent piezoelectric element 11.

Specifically, in the embodiment, the external electrode 20 is separated into a portion opposing each piezoelectric element 11 and a portion opposing the positioning unit 19, and an area of the external electrode 20 opposing each piezoelectric element 11 constitutes the individual external electrode 22 electrically connected to the individual internal electrode 16 constituting the individual electrode of the piezoelectric element 11 at the distal end of the piezoelectric element forming member 13. On the other hand, the external electrodes 20 above the positioning units 19 provided at the both side of the line 12 of the piezoelectric elements 11 constitutes the common external electrode 23 that is connected to the common internal electrode 17 constituting the common electrode of each piezoelectric element 11 at an end surface of the distal end side of the piezoelectric element forming member 13.

That is, in the piezoelectric element unit 10 of the embodiment, the individual external electrodes 22 are provided in parallel on the surface opposite to the portion to which the fixing substrate 14 of the piezoelectric element forming member 13 is connected, and the common external electrodes 23 exist at areas of the both sides of the individual external electrodes 22 provided in parallel and at areas opposing the positioning units 19. Herewith, the piezoelectric unit 10 and a wiring substrate described below can be comparatively easily connected and the piezoelectric unit 10 can be downsized.

In the piezoelectric element unit 10, a surface of the fixing substrate 14 opposite to the surface on which the piezoelectric forming member 13 is fixed is fixed to the accommodation unit 58a of the head case 58 as shown in FIGS. 1A and 1B. Then, an external circuit board, for example, a film-like wiring substrate 30 for supplying a signal for driving each piezoelectric element 11 is connected to the piezoelectric element unit 10.

A driving IC 31 for supplying a driving signal for driving each piezoelectric element 11 is mounted on the wiring substrate 30, and the wiring substrate 30 is a film-like substrate in which a connection wiring 33 which is connected with the individual external electrode 22 and the common external electrode 23 of the piezoelectric element 11 is provided. As for the wiring substrate 30, for example, there is included a tape carrier package (TCP) such as a TAB tape. That is, the wiring substrate 30 is formed as described below. A conductive layer having a predetermined pattern is formed with a copper foil or the like on a surface of a base film 32 formed by a polyimide or the like to form the connection wiring 33 by plating the conductive layer, and thereafter the connection wiring 33 is covered by an insulation film 34 such as a resist except areas at which the piezoelectric element 11 and a terminal unit described below are connected and an area at which a terminal of the driving IC 31 is connected. Further, the driving IC 31 is mounted on the wiring substrate 30, and thereafter the driving IC 31 is covered with the insulation film 34.

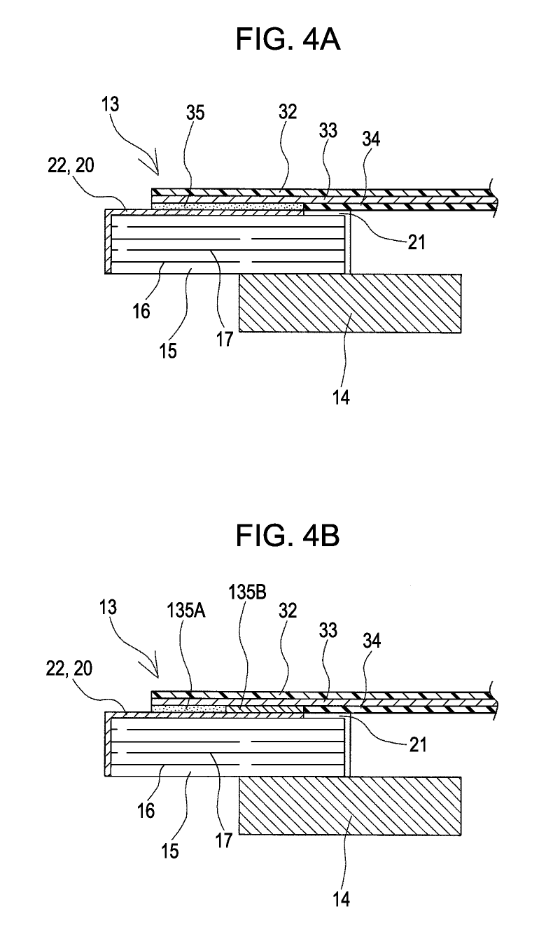

The driving IC 31 is located at a surface side of the wiring substrate 30 opposing the fixing substrate 14, and the driving IC 31 is disposed so as to be located at the center area of the wiring substrate 30 in a width direction. Then, as shown in FIGS. 1A, 1B, and FIG. 4A, an end of the connection wiring 33 and each of the individual external electrode 22 and the common external electrode 23 at the end side at which the piezoelectric element 11 and the fixing substrate 14 are fixed are electrically and mechanically connected via a connection layer 35 made of an anisotropic conductive material. The piezoelectric element 11 has a non-active portion whose area is united with the fixing substrate 14 and an active portion whose area is not united with the fixing substrate 14. Then, the connection layer 35 is formed in the non-active portion and not in the active portion of the piezoelectric element 11. Accordingly, the connection layer 35 almost never disturbs driving of the piezoelectric element 11. Then, it is preferable that the thickness of the connection layer 35 and the thickness of the piezoelectric element 11 in the direction parallel with the vibration plate 55 do not inflect the wiring substrate 30 between a second ultraviolet cure adhesive 41 and the connection layer 35 when the wiring substrate 30 is fixed with the second ultraviolet cure adhesive 41. Unless the relationship is satisfied, there is a fear in that the wiring substrate 30 is bent between the connection layer 35 and the second ultraviolet cure adhesive 41 and the wiring substrate 30 is peeled off from the connection layer 35 or the second ultraviolet cure adhesive 41 at the vicinity of the connection layer 35 or the second ultraviolet cure adhesive 41. Note that a general idea of the non-active portion is not limited to the mode in which the piezoelectric element 11 is fixed to the fixing substrate 14, and includes a wide general idea in which the area which is difficult to move than the active portion due to uniting of the piezoelectric element 11 with another member except the vibration plate 55 and the wiring substrate 30 is included.

Note that, as for the anisotropic conductive material, for example, there are included an anisotropic conductive film (ACF), an anisotropic conductive paste (ACP), and the like. Incidentally, as for the anisotropic conductive material, for example, the one in which nickel plating is formed on an epoxy resin and a resin ball which is conventionally well known can be used.

In this manner, the connection wiring 33 and external electrode 20 are connected via the connection layer 35 made of an anisotropic conductive material. Herewith, both of an electrical connection and a mechanical connection are provided by the connection wiring 33. Accordingly, the bonding area of the connection wiring 33 and external electrode 20 can be increased to improve the bonding strength. That is, as in a conventional structure shown in FIG. 4B, for example, when the connection wiring 33 and the external electrode 20 are bonded with a connection layer 135A formed by a solder and a connection layer 135B formed by a solder mask 135B, an bonding surface of the connection layer 135B formed by a solder mask for providing a mechanical strength is narrow to decrease the bonding strength.

Herein, a bonding strength in the case where the connection wiring 33 and the external electrode 20 are connected with the connection layer 35 formed by an anisotropic conductive film (ACF) as shown in FIG. 4A, and a bonding strength in the case where the connection wiring 33 and the external electrode 20 are connected by the connection layer 135A formed by a solder and the connection layer 135B formed by a solder mask as in the conventional structure shown in FIG. 4B were measured. Note that, the measurement was performed by pulling the wiring substrate 30 and the piezoelectric element unit 10 by a pulling test machine. As the result, as shown in FIG. 4A, the bonding strength in the case where connected with the connection layer 35 formed by an anisotropic conductive film was not less than 4 N. On the contrary, the bonding intensity in the case where connected with the connection layer 135A formed by a solder and the connection layer 135B formed by a solder mask was about 2.5 N.

In this manner, by connecting the connection wiring 33 and the external electrode 20 via the connection layer 35 formed by an anisotropic conductive film, the bonding strength can be improved as compared with the case where the connection wiring 33 and the external electrode 20 are connected by a solder and a solder mask. Accordingly, when treating the ink jet type recording head I, a disadvantage that the connection wiring 33 is peeled off from the external electrode 20 can be surely prevented to improve reliability.

Further, by connecting the connection wiring 33 and the external electrode 20 via the connection layer 35 made of an anisotropic conductive material, a component the anisotropic conductive material (for example, a resin or the like) is filled between the external electrodes 20 and between the connection wirings 33. Herewith, current leakage occurred therebetween, so called migration can be surely prevented. Accordingly, it is not necessary to prevent prevention of the migration with a flux or the like used for soldering, so that reliability can be easily improved.

Further, by connecting the connection wiring 33 and the external electrode 20 with the connection layer 35 made of an anisotropic conductive material, it becomes not necessary to plating a surface of the connection wiring 33 and the external electrode 20 with gold which is necessary for connecting with a solder. Accordingly, the cost can be reduced. Specifically, it is necessary to plating the external electrode 20 with, for example, tin-phosphorus. Further, if the connection wiring 33 is formed by one layer made of tin, the external electrode 20 and the connection wiring 33 can be surly electrically connected with the connection layer 35 made of an anisotropic conductive material.

On the other hand, the other end of the connection wiring 33 of the wiring substrate 30 opposite to the end connected to the piezoelectric element 11 is connected to a terminal unit 61a of an input wiring 61 of an input wiring substrate 60 provided at a surface of the head case 58 opposite to the vibration plate 55 via a folded area.

Herein, the input wiring substrate 60 provided on the head case 58 is to supply a driving voltage, a print signal, and the like to the driving IC 31 and the piezoelectric element 11 from outside. Then, since the input wiring substrate 60 is provided on a surface of the head case 58 opposite to the vibration plate 55, the wiring substrate 30 connected to the piezoelectric element 11 fixed to the accommodation unit 58a is bent by about 90 degrees at a portion connected with the terminal unit 61a of the input wiring 61 of the input wiring substrate 60, and an end of the connection wiring 33 is connected with the terminal unit 61a. Then, for example, after a metal such as tin-phosphorus copper alloy is formed on a surface of the terminal unit 61a of the input wiring 61, the connection wiring 33 and the terminal unit 61a are electrically connected via a metal layer 36 formed by applying heat in the stat where the connection wiring 33 and the terminal unit 61a are made contact with the metal.

In addition, the wiring substrate 30 is bonded with the fixing substrate 14 via an ultraviolet cure adhesive (UV adhesive). To be more specific, the wiring substrate 30 and the fixing substrate 14 are bonded via a first ultraviolet cure adhesive 40 and the second ultraviolet cure adhesive 41. The first ultraviolet cure adhesive 40 opposes the driving IC 31 of the wiring substrate 30 and bonds the driving IC 31 and to the fixing substrate 14. The second ultraviolet cure adhesive 41 is provided at both sides of the area to which the first ultraviolet cure adhesive 40 is applied in the width direction of the driving IC 31 which is a direction in which the piezoelectric elements 11 are disposed in parallel and provided so as to be located closer to the terminal unit 61a than the first ultraviolet cure adhesive 40.

Further, in the embodiment, the wiring substrate 30 and the fixing substrate 14 are bonded via a third ultraviolet cure adhesive 42. The third ultraviolet cure adhesive 42 is provided at both sides of the driving IC 31 in the direction in which the piezoelectric elements 11 are disposed in parallel (width direction of the wiring substrate 30) outside the areas in which the second ultraviolet cure adhesive 42 is provided, and on a straight line passing through the first ultraviolet cure adhesive 40 that is in parallel with the width direction of the wiring substrate 30. Herein, “a straight line” includes not also a perfect straight line but also a line that can be regard as a straight line when viewed from the entire wire substrate 30 although having some declination.

That is, in the embodiment, the wiring substrate 30 and the fixing substrate 14 are bonded at five portions in total with the first ultraviolet cure adhesive 40 provided at one portion, the second ultraviolet cure adhesive 41 provided at two portions, and third ultraviolet cure adhesive 42 provided at two portions. The first ultraviolet cure adhesive 40, the second ultraviolet cure adhesive 41, and the third ultraviolet cure adhesive 42 are disposed to form an approximately M character shape when viewed from a direction so that the piezoelectric elements 11 are viewed in the vertically lower direction.

In this manner, by providing the first ultraviolet cure adhesive 40 and the second ultraviolet cure adhesive 41, even when the other end of the wiring substrate 30 opposite to one end connected to the piezoelectric element 11 is bent for connecting the connection wiring 33 of the wiring substrate 30 and the terminal unit 61a of the input wiring 61 of the input wiring substrate 60 on the head case 58, occurrence of a disadvantage that the strength of the connecting portion is weekend and the connecting portion is pealed off can be prevented by preventing that a stress is applied to the connecting portion between the connection wiring 33 of the wiring substrate 30 and the piezoelectric element 11.

Further, by providing the first ultraviolet cure adhesive 40 and the second ultraviolet cure adhesive 41, deformation of the wiring substrate 30 can be prevented by improving folding property when the wiring substrate 30 is bent.

Further, in the embodiment, by providing the third ultraviolet cure adhesive 42, it can be more surely prevented that a stress is applied to the connecting portion between the wiring substrate 30 and the piezoelectric element 11 when the wiring substrate 30 is bent.

Further, by bonding the driving IC 31 of the wiring substrate 30 and the fixing substrate 14 with the first ultraviolet cure adhesive 40, heat generated in the driving IC 31 is diffused into the fixing substrate 14 via the first ultraviolet cure adhesive 40. Accordingly, destruction or the like of the driving IC 31 caused by the heat can be prevented.

Further, by providing the first ultraviolet cure adhesive 40, the second ultraviolet cure adhesive 41, and the third ultraviolet cure adhesive 42, even when the wiring substrate 30 is touched when handling the ink jet type recording head, it can be prevented that a stress is applied at the connecting portion between the connection wiring 33 of the wiring substrate 30 and the piezoelectric element 11 and the connecting portion between the connection wiring 33 and the terminal unit 61a of the had case 58. Herewith, occurrence of disadvantages that the strength of the connecting portions is weakened and the connecting portions are peeled off can be prevented. That is, as described above, an effect in which an electrical and mechanical bonding strength between the connection wiring 33 and the external electrode 20 can be improved by connecting the connection wiring 33 and the external electrode 20 with the connection layer 35 made of an anisotropic conductive material, and an effect in which it is prevented that a stress is applied to the connecting portion between the external electrode 20 and the connection wiring 33 by fixing the wiring substrate 30 and the fixing substrate 14 with the first ultraviolet cure adhesive 40, the second ultraviolet cure adhesive 41, and the third ultraviolet cure adhesive 42 can be obtained. With the synergistic effect, occurrence of disadvantages that the strength of the connecting portions is weakened and the connecting portion is peeled off can be surly prevented.

Further, by disposing the first ultraviolet cure adhesive 40, the second ultraviolet cure adhesive 41, and the third ultraviolet cure adhesive 42 so as to form an approximately M character shape, the first ultraviolet cure adhesive 40, the second ultraviolet cure adhesive 41, and the third ultraviolet cure adhesive 42 can be cured by irradiating ultraviolet light by a UV nozzle from the width direction of the wiring substrate 30. That is, a space between the wiring substrate 30 and the fixing substrate 14 is opened in the width direction of the wiring substrate 30. Accordingly, it is necessary that the first ultraviolet cure adhesive 40, the second ultraviolet cure adhesive 41, and the third ultraviolet cure adhesive 42 are disposed at positions so that ultraviolet light irradiated from the both sides of the space between the wiring substrate 30 and the fixing substrate 14 that is opened in the width direction is irradiated thereto. For example, when the first ultraviolet cure adhesive 40, the second ultraviolet cure adhesive 41, and the third ultraviolet cure adhesive 42 are provided in parallel in the width direction of the wiring substrate 30, when ultraviolet light is irradiated from the both sides of the width direction of the wiring substrate 30, the first ultraviolet cure adhesive 40 and the second ultraviolet cure adhesive 41 are hidden by the third ultraviolet cure adhesive 42. Accordingly, there is a fear that curing of the first ultraviolet cure adhesive 40 and the second ultraviolet cure adhesive 41 becomes insufficient.

Note that such an irradiation of ultraviolet light from a UV nozzle is performed in the state where the wiring substrate 30 is held in parallel with the fixing substrate 14. The reason is to prevent that the wiring substrate 30 is deflected to the fixing substrate 14 side by the self weight of the wiring substrate 30. Further, the irradiation time of ultraviolet light by a UV nozzle is about five seconds. In this manner, the wiring substrate 30 and the fixing substrate 14 are bonded via the first ultraviolet cure adhesive 40, the second ultraviolet cure adhesive 41, and the third ultraviolet cure adhesive 42 and curing the adhesive at approximately a same time, the curing time can be reduced to reduce manufacturing cost. That is, for example, when a thermal cure adhesive is used as an adhesive for bonding the wiring substrate 30 and the fixing substrate 14, it becomes necessary to perform a batch processing and it takes a time for heating. This increases cost.

Further, the first ultraviolet cure adhesive 40, the second ultraviolet cure adhesive 41, and the third ultraviolet cure adhesive 42 can be easily applied in desired areas by using, for example, a dispenser. Further, for example, five nozzles for letting out the ultraviolet cure adhesive are provided in the dispenser and the nozzles are disposed at desired positions. Herewith, the first ultraviolet cure adhesive 40, the second ultraviolet cure adhesive 41, and the third ultraviolet cure adhesive 42 can be easily applied at the desired positions at a same time. This makes the operation easy to reduce cost.

Further, the first ultraviolet cure adhesive 40, the second ultraviolet cure adhesive 41, and the third ultraviolet cure adhesive 42 may be applied by a hand working. In such a case, for example, the second ultraviolet cure adhesive 41 can be easily applied by regarding the corner of the insulation film 34 covering the driving IC 31 as a mark. Further, for example, the third ultraviolet cure adhesive 42 can be easily applied by regarding a damper or the like not shown provided when forming the wiring substrate 30 as a mark. That is, by applying the first ultraviolet cure adhesive 40, the second ultraviolet cure adhesive 41, and the third ultraviolet cure adhesive 42 by regarding the driving IC 31, the insulation film 34, or the like as a mark, the ultraviolet cure adhesive can be applied at same positions for a plurality of products to improve yield rate.

Note that, in the ink jet type recording head I constituted in this manner, ink is supplied to the reservoir 53 via an ink supply route communicated with an ink cartridge and distributed into each pressure generating chamber 52 via the ink supply opening 54. Practically, a voltage is applied to the piezoelectric element 11 to contract the piezoelectric element 11. Herewith, the vibration plate 55 is pulled up with the piezoelectric element 11 to increase the volume of the pressure generating chamber 52, and ink is drawn into the pressure generating chamber 52. Then, after the inside of the pressure generating chamber 52 including the nozzle opening 56 is filled with the ink, the voltage applied to the piezoelectric element 11 is released in accordance with a recording signal transmitted from the driving IC 31, and the piezoelectric element 11 is extended to become an original state. Herewith, the vibration plate 55 is also displaced and returned to an original place. Accordingly, the pressure generating chamber 52 is contracted and the inner pressure is increased, and an ink drop is ejected from the nozzle opening 56.

### Other Embodiments

The first embodiment of the invention is described above. However, the basic structure of the invention is not limited to the aforementioned structure. For example, in the first embodiment, the first ultraviolet cure adhesive 40, the second ultraviolet cure adhesive 41, and the third ultraviolet cure adhesive 42 are provided. However, by providing at least the first ultraviolet cure adhesive 40 and the second ultraviolet cure adhesive 41, it can be prevented that a stress is applied to the connecting portion of the connection wiring 33 of the wiring substrate 30 and the piezoelectric element 11. Accordingly, it is possible to prevent occurrence of a disadvantage that strength of the connecting portion is weakened and the connecting portion is pealed off.

Further, in the first embodiment, the first ultraviolet cure adhesive 40, the second ultraviolet cure adhesive 41, and the third ultraviolet cure adhesive 42 are arranged to form an approximately M character shape when viewed from a direction so that the piezoelectric elements 11 are viewed in the vertically lower direction. However the arrangement is not limited thereto.

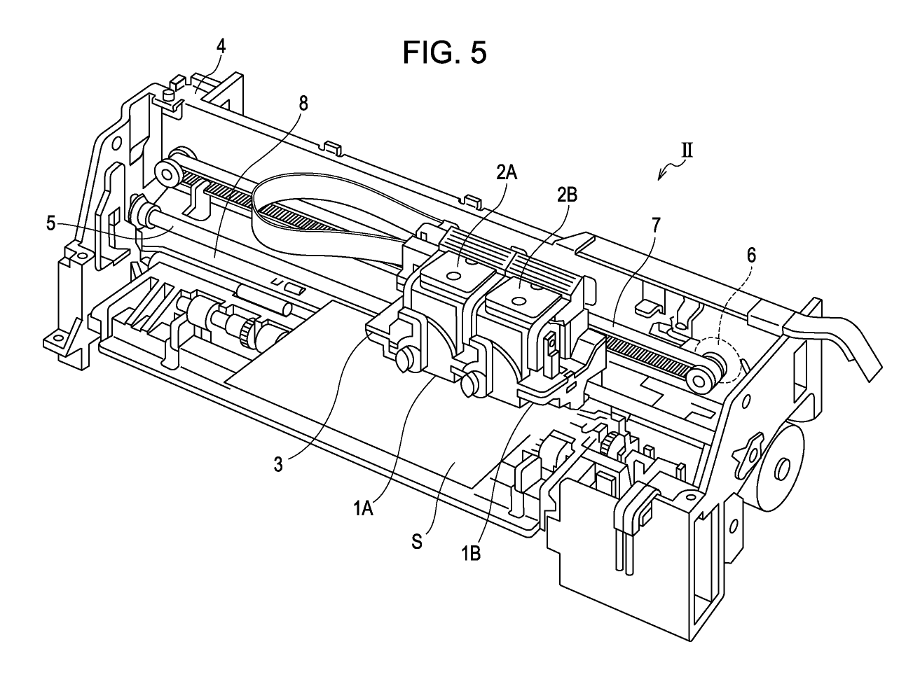

Note that, the ink jet type recording head of the first embodiment constitutes a part of a recording head unit equipped with an ink flow path communicated with an ink cartridge or the like, and is mounted in the ink jet type recording apparatus. FIG. 5 is a diagram schematically showing an example of the ink jet type recording apparatus.

As shown in FIG. 5, an ink jet type recording apparatus II is equipped with recording head units 1A and 1B each having the ink jet type recording head I. The recording head units 1A and 1B are provided so that cartridges 2A and 2B constituting ink supply means can be attached and detached. A carriage 3 mounting the recording units 1A and 1B is provided on a carriage axis 5 attached to a device main body 4 so as to be freely moved in the axis direction. The recording head units 1A and 1B respectively eject, for example, a black ink composition and a color ink composition.

Then, a driving force of a driving motor 6 is transmitted to the carriage 3 via a plurality of gears not shown and a timing belt 7. Herewith, the carriage 3 mounting the recording head units 1A and 1B is moved along the carriage axis 5. On the other hand, a platen 8 is provided in the device main body 4 along the carriage axis 5, and a recording sheet S which is a recording medium such as a paper fed by a feed roller and the like not shown is wound around the platen 8 to be transported.

Note that, in the first embodiment, the ink jet type recording head is employed as an example of a liquid ejecting head. However, the invention is widely used for a general liquid ejecting head. Accordingly, the invention can be also applied to a manufacturing method of a liquid ejecting head for ejecting liquid except ink. In addition to the ink jet head, the liquid ejecting head encompasses, for example, various recording heads used for an image recording apparatus such as a printer, a coloring material ejecting head used for manufacturing a color filter such as a liquid crystal display, an electrode material ejecting head used for forming electrodes such as an organic EL display, a field emission display (FED), or the like, a bio-organic substance ejecting head used for manufacturing a bio-chip, and the like.

What is claimed is:

1. A liquid ejecting head comprising:
an piezoelectric element unit equipped with internal electrodes respectively constituting two poles are alternatively laminated to sandwich a piezoelectric material layer, the piezoelectric element unit having an external connecting portion connected to each of the internal electrodes of each pole on an outer surface of the piezoelectric element unit; and
an external circuit board on which a driving IC for driving the piezoelectric element unit is provided and in which a connection wiring which is electrically connected to the piezoelectric element unit is provided, wherein
the external connecting portion of the piezoelectric element unit and the connection wiring of the wiring substrate are electrically connected via a connection layer made of an anisotropic conductive material.

2. The liquid ejecting head according to claim 1, wherein the piezoelectric element unit having piezoelectric elements the piezoelectric elements and the external connecting portions are separated by slits and an electrode non-formed portion in which the external connecting portion is not formed, and the connection layer is provided from an end of the connection wiring to the electrode non-formed portion.

3. The liquid ejecting head according to claim 1, wherein the connection layer is provided between the adjacent external connecting portions.

4. The liquid ejecting head according to claim 1 further comprising:
a fixing substrate connected to the piezoelectric element unit at a side opposite to a pressure generating chamber; and
a head case having an accommodation unit in which the piezoelectric element unit is accommodated and a terminal unit to which an end of the wiring substrate is electrically connected, wherein
the wiring substrate is provided to extend from inside the accommodation unit to outside and is electrically connected to the terminal unit via a folded area, and the driving IC is provided in an area opposing the fixing substrate, and
the wiring substrate and the fixing substrate are bonded via a first ultraviolet cure adhesive for bonding the driving IC and the fixing substrate, the first ultraviolet cure adhesive being provided in an area opposing the driving IC, and the second ultraviolet cure adhesive provided at both sides of the area to which the first ultraviolet cure adhesive is applied of the driving IC in a direction in which the piezoelectric element unit is disposed in parallel and provided so as to be located closer to the terminal unit than the first ultraviolet cure adhesive.

5. A liquid ejecting apparatus comprising the liquid ejecting head according to claim 1.
